(19) United States
(12) Patent Application Publication
(10) Pub. No.: US 2007/0204122 A1
(43) Pub. Date: Aug. 30, 2007

(54) Multimedia Three-Dimensional Memory (M3DM) System

(76) Inventor: Guobiao ZHANG, Stateline, NV (US)

Correspondence Address: GUOBIAO ZHANG, P.O. BOX 6182, STATELINE, NV, 89449-6182, US

(21) Appl. No.: 11/736,757

(22) Filed: Apr. 18, 2007

Related U.S. Application Data
(63) Continuation-in-part of application No. 11/164,246, filed on Nov. 15, 2005.
Application No. 11/164,246 is a continuation-in-part of application No. 11/036,448, filed on Jan. 15, 2005.
(60) Provisional application No. 60/559,683, filed on Apr. 4, 2004.

(51) Int. Cl. G06F 12/00

(52) U.S. Cl. 711/163

(57) ABSTRACT

Among all semiconductor memory technologies, three-dimensional memory (3D-M), particularly mask-programmable 3D-M (3D-MPM), has the largest storage capacity and is the only one that can store movies at a reasonable price. Accordingly, the present invention discloses a multimedia three-dimensional memory (M3DM).

### CROSS-REFERENCE TO RELATED APPLICATIONS

This application is a continuation-in-part of U.S. patent application Ser. No. 11/164,246, “User-Configurable Pre-Recorded Memory”, filed Nov. 15, 2005, which is a continuation-in-part of U.S. patent application Ser. No. 11/036,448, “User-Configurable Pre-Recorded Memory”, filed Jan. 15, 2005, which is related to U.S. Provisional Application No. 60/559,683, “Improved Three-Dimensional Memory”, filed Apr. 4, 2004 and Chinese P.R. patent application No. 200410081241.X, “Layout Design of Three-Dimensional Memory”, filed Nov. 15, 2004.

### BACKGROUND

1. Technical Field of the Invention

The present invention relates to the field of integrated circuit, and more particularly to semiconductor memory.

2. Related Arts

Consumers desire to access as much multimedia contents as possible while on the go. To satisfy this desire, various multimedia-distribution models have been disclosed. One model is the “download” model, i.e. multimedia contents are wirelessly downloaded by a mobile user from the internet. However, at present or in the near future, fast, pervasive and reliable wireless internet access is not readily available. This makes multimedia download, particularly movie download, difficult. Another model is the “pre-recorded” model, i.e. pre-recorded multimedia contents (PMC) have been recorded in a mobile mass storage (i.e. mass storage used in a mobile device) before it is distributed to a user.

Multimedia contents could be textual (e.g. books), audio (e.g. songs), image (e.g. GPS maps, photos), video (e.g. movies) and others. For mobile users, semiconductor memory is the preferred storage medium for multimedia contents because of its small size and ruggedness. Among the existing semiconductor memory technologies, flash memory is considered by prior arts as the best candidate. At present, flash memory can store a large number of textual, audio and image contents with an average storage cost per content comparable to or less than conventional means. Take songs as an example. Each song requires ˜4 MB space. Because 2 GB flash costs ˜$12, the average storage cost per song for flash is ˜$0.024. This is comparable to the conventional means. In the conventional means, CD is used to distribute songs and its average storage cost per song ranges from $0.01 to $0.04.

Compared with songs, movies are much more difficult to be distributed in flash memory. Because movies require a much larger space (˜500 MB/movie) than songs (˜4 MB/song), flash memory is too expensive for movie distribution—its average storage cost per movie is ˜$3, which is significant compared with the average selling price of a movie (˜$10) and is much higher than the conventional means. In the conventional means, DVD is used to distribute movies and its average storage cost per movie ranges just from $0.30 to $0.70. To overcome this and other difficulties, the present invention discloses a multimedia three-dimensional memory (M3DM).

### Objects and Advantages

It is a principle object of the present invention to satisfy the mobile user's desire to obtain movies at a reasonable price.

It is a further object of the present invention to protect both interests of consumers and copyright owners.

It is a further object of the present invention to lower the entry barrier for multimedia contents.

In accordance with these and other objects of the present invention, the present invention discloses a multimedia three-dimensional memory (M3DM).

### SUMMARY OF THE INVENTION

The present invention follows a “pre-recorded” model to distribute multimedia contents. For mobile users, semiconductor memory is the preferred storage medium for multimedia contents, because of its small size and ruggedness. Pre-recorded multimedia contents (PMC), particularly movies, place stringent requirements on semiconductor memory in storage cost. The average storage cost per movie should be comparable to the conventional means. In the conventional means, DVD is used to distribute movies and its average storage cost per movie ranges from $0.30 to $0.70. With the advent of three-dimensional memory (3D-M, referring to U.S. Pat. No. 5,835,396 and others), particularly three-dimensional mask-programmable memory (3D-MPM), these stringent requirements can be met. Accordingly, the present invention discloses a multimedia three-dimensional memory (M3DM).

An M3DM is a three-dimensional memory (3D-M) containing pre-recorded multimedia contents (PMC). Here, 3D-M is a semiconductor memory comprising a plurality of vertically stacked memory levels. Among all semiconductor memory technologies, 3D-M, particularly mask-programmable 3D-M (3D-MPM), has the largest storage capacity (FIG. 1/Table 1, where “˜” means an estimated value, “?” means it is questionable to scale down to this node) and is the only one that can store a movie at a reasonable price. Its average storage cost per movie is comparable to the conventional means—DVD, whose average storage cost per movie ranges from $0.30 to $0.70. For example, at the 50 nm node, a 3D-MPM can store ˜16 GB, or 30 movies, with average storage cost per movie ˜$0.40; at the 17 nm node, a 3D-MPM can store ˜128 GB, or 250 movies, with average storage cost per movie ˜$0.05. This is unimaginable for any of the existing semiconductor storage technologies.

Because an M3DM contains a large amount of multimedia contents, if full access is granted at the moment of distribution, a user will be charged a hefty upfront fee for the copyrights of all contents therein. Apparently, the user is not willing to pay copyright fees for the contents he is not interested in. To protect both interests of consumers and copyright owners, access to the PMC should be controlled in such a way that a user only pays when he accesses. With access control, hardware cost can be distributed through access fees and therefore, a user can obtain the hardware (e.g. M3DM) at a nominal price. This will lower the entry barrier for the M3DM.

At present, flash memory represents the most advanced transistor technology. In 2007, flash memory in mass production uses the 50 nm technology. As is well known to those skilled in the art, transistor scaling involves many factors, e.g. lithography, gate material, gate dielectric material, channel/source/drain engineering and others. On the other hand, diode scaling is much simpler: it is more or less limited by lithography alone. Thus, diode follows different scaling laws than transistor: 1) the diode minimum feature-size f could be smaller than the transistor minimum feature-size F; 2) the diode scaling can occur at a much faster rate than transistor.

Accordingly, the present invention discloses a narrow-line three-dimensional memory (NL-3DM). It comprises at least one diode-based memory level (3D-M level) stacked above the substrate. The minimum feature-size of the diode-based memory level (3D-M level) is smaller than the contemporary transistor-based memory (e.g. flash). Here, contemporary transistor-based memory refers to the most advanced transistor-based memory that is in mass production at the same time as the diode-based memory.

### BRIEF DESCRIPTION OF THE DRAWINGS

FIG. 1 (Table 1) lists the storage capacity of various semiconductor memories;

FIG. 2 is a cross-sectional view of a three-dimensional memory (3D-M);

FIG. 3A illustrates a preferred M3DM system; FIG. 3B is a simplified block diagram of the preferred M3DM system;

FIG. 4 illustrates a preferred access method;

FIG. 5A illustrates a preferred payment process; FIG. 5B illustrates a preferred playback process;

FIG. 6 illustrates a preferred sequence to select accessibility;

FIG. 7 illustrates a preferred user interface to select accessibility;

FIG. 8 is a block diagram of a preferred access-control block;

FIGS. 9A-9B illustrate two preferred integrated M3DM's;

FIG. 10 is a simplified block diagram of the preferred M3DM system containing multi-sourced contents;

FIG. 11 A is a cross-sectional view of a preferred narrow-line 3D-MPM; FIG. 11 B is its top view.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

The present invention follows a “pre-recorded” model to distribute multimedia contents. For mobile users, semiconductor memory is the preferred storage medium for multimedia contents, because of its small size and ruggedness. Pre-recorded multimedia contents (PMC), particularly movies, place stringent requirements on semiconductor memory in storage cost. The average storage cost per movie should be comparable to the conventional means. In the conventional means, DVD is used to distribute movies and its average storage cost per movie ranges from $0.30 to $0.70. With the advent of three-dimensional memory (3D-M, referring to U.S. Pat. No. 5,835,396 and others), particularly three-dimensional mask-programmable memory (3D-MPM), these stringent requirements can be met. Accordingly, the present invention discloses a multimedia three-dimensional memory (M3DM).

An M3DM is a three-dimensional memory (3D-M) containing pre-recorded multimedia contents (PMC). Here, 3D-M is a semiconductor memory comprising a plurality of vertically stacked memory levels. Among all semiconductor memory technologies, 3D-M, particularly mask-programmable 3D-M (3D-MPM), has the largest storage capacity (FIG. 1/Table 1, where “˜” means an estimated value, “?” means it is questionable to scale down to this node) and is the only one that can store a movie at a reasonable price. Its average storage cost per movie is comparable to the conventional means—DVD, whose average storage cost per movie ranges from $0.30 to $0.70. For example, at the 50 nm node, a 3D-MPM can store ˜16 GB, or 30 movies, with average storage cost per movie ˜$0.40; at the 17 nm node, a 3D-MPM can store ˜128 GB, or 250 movies, with average storage cost per movie ˜$0.05. This is unimaginable for any of the existing semiconductor storage technologies.

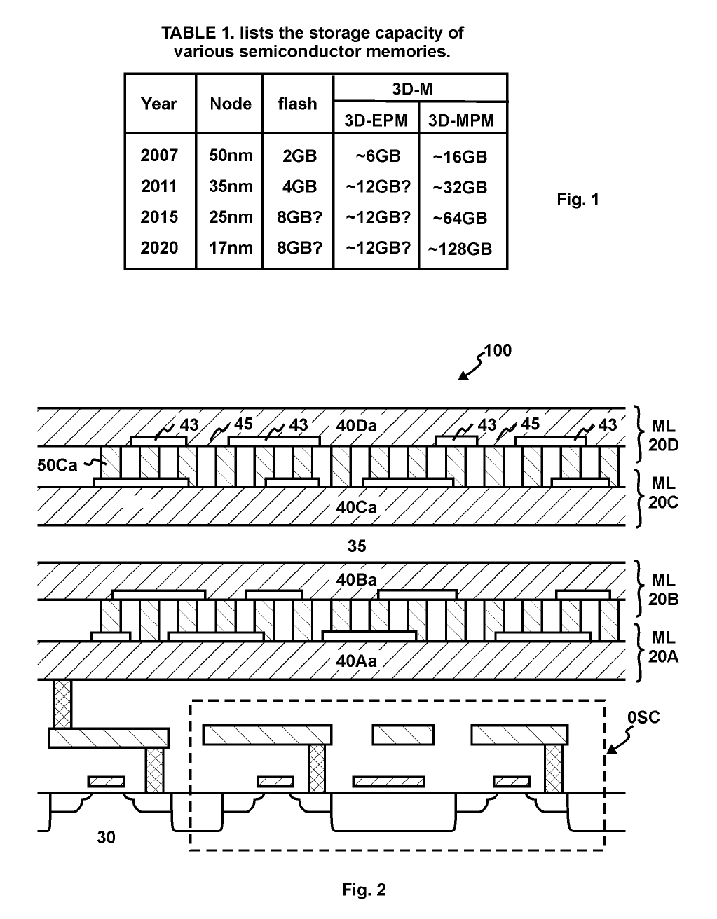

FIG. 2 is a cross-sectional view of a preferred 3D-M 10. 3D-M could be electrically-programmable (3D-EPM) or mask-programmable (3D-MPM). This preferred 3D-M is a 3D-MPM. It comprises four memory levels 20A-20D, which are stacked above each another. These memory levels are further stacked above a substrate 30. Each memory level (e.g. 20D) comprises word lines (e.g. 40Da), bit lines (e.g. 50Ca) and info-dielectric 43. Memory cells are located at the intersection between word lines and bit lines. The existence or absence of openings 45 in the info-dielectric 43 determines the information stored in memory cells. Note that the memory cells do not occupy substrate 30 and therefore, the substrate 30 can be used to form substrate circuit 0SC, as will become apparent in FIGS. 9A-9B.

This preferred embodiment uses a number of ways to increase the storage capacity and lower the manufacturing cost, including: 1) nF-opening (n>1), i.e. the dimension of the opening 45 is larger than the width F of the address line (e.g. 50Ca) (referring to U.S. Pat. No. 6,903,427); 2) N-ary MPM (N>2), i.e. each MPM cell has N possible states and stores more than one bit (referring to U.S. patent application Ser. No. 11/162,262); 3) hybrid-level 3D-M, i.e. some adjacent memory levels share address lines (e.g. memory levels 20C, 20D share address line 50Ca), while other adjacent memory levels do not (e.g. memory levels 20B, 20C are separated by an inter-level dielectric 35) (referring to China, P.R. Patent Application 200610162698.2).

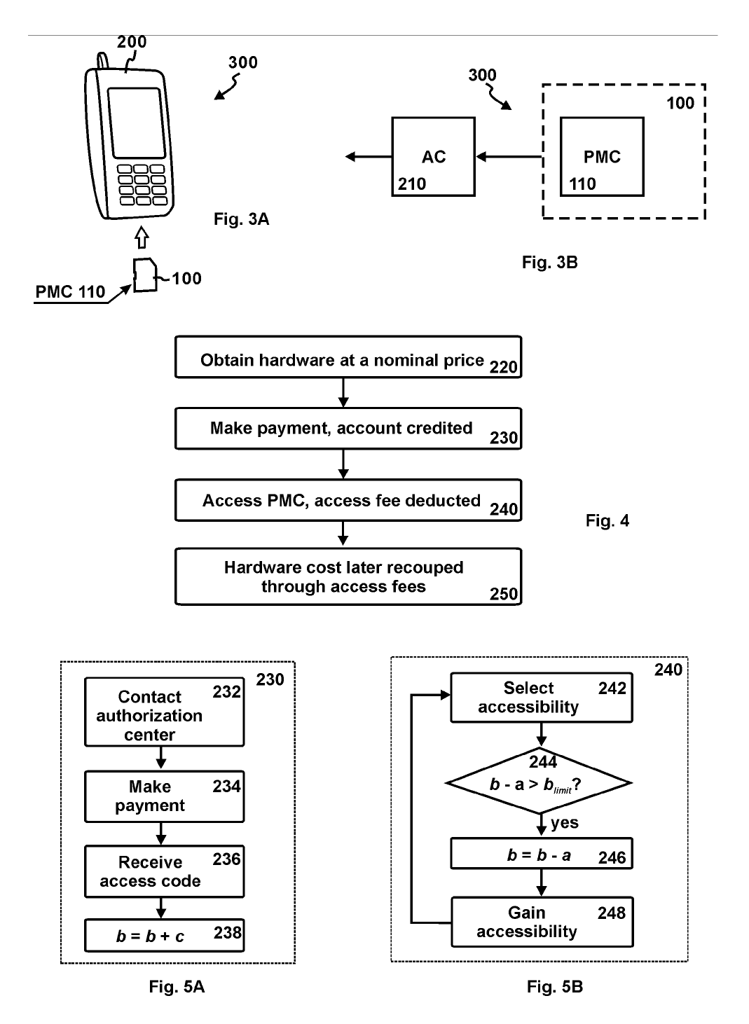

FIG. 3A illustrates a preferred mobile playback system associated with the M3DM, or M3DM system 300. It comprises an M3DM 100 and a mobile device 200. The M3DM 100 contains pre-recorded multimedia contents (PMC) 110. The mobile device 200 plays back selected multimedia contents from the PMC 110. A preferred mobile device 200 is cellular phone. The M3DM 100 can be removable (i.e. it can be inserted into or removed from the mobile device 200). It can also be embedded into the mobile device 200.

Because an M3DM 100 contains a large amount of copyrighted contents, if full access is granted at the moment of distribution, a user will be charged a hefty upfront fee for the copyrights of all contents therein. Apparently, the user is not willing to pay copyright fees for the contents he is not interested in. To protect both interests of consumers and copyright owners, access to the PMC 110 should be controlled in such a way that a user only pays when he accesses.

FIG. 3B is a simplified block diagram of the preferred M3DM system 300. It comprises an M3DM 100 and an access-control block (AC) 210. The AC 210 controls access to the PMC 110 in the M3DM 100. To protect copyright, content data are preferably encrypted. The M3DM system 300 keeps track of an account balance (b), which records credit from payment and debit from usage. The AC 210 can be physically located in the M3DM 100 (referring to FIGS. 9A-9B), or in the mobile device 200. Another possibility is that a portion of AC 210 is physically located in the mobile device 200, with the remaining portion located in the M3DM 100.

FIG. 4 illustrates a preferred access method. It comprises a payment process 230 and a playback process 240. During the payment process 230, a user makes payment and his account is credited. During the playback process 240, the user accesses selected contents in the PMC 110 and corresponding access fees are deducted from his account. Because access fees include not only the copyright fees, but also a portion of the hardware cost, the user could initially pay a nominal price for the M3DM 100 (step 220), and the hardware cost can later be recouped from access fees (step 250). This can lower the entry barrier for the PMC.

FIG. 5A illustrates a preferred payment process 230. At first, the user contacts an authorization center (step 232). After the user makes payment (step 234), the authorization center issues an access code (step 236), which results in an addition of the credit (c) to the account balance, i.e. b=b+c (step 238).

FIG. 5B illustrates a preferred playback process 240. At first, the user selects the desired accessibility (step 242). Then the remaining balance will be calculated, which is the difference between the existing balance and the access fee (a). As long as the remaining balance is above a threshold bₗᵢₘᵢₜ (step 244), the user can obtain the desired accessibility (step 248) and the corresponding access fee is deducted from the account balance, i.e. b=b−a (step 246). Note that payment process 230 can occur before the playback process 240 (like a pre-paid phone card, or debit card), or after the playback process 240 (like a credit card).

In FIGS. 4-5B, the account balance is stored in the M3DM system 300. Only during the payment process 230, does the M3DM system 300 need to contact the authorization center. Because the authorization center is located remotely, this contact process needs to be carried out by a telecommunication means, such as telephone (landline or cellular) or internet (wired or wireless). During the playback process 240, the M3DM system 300 can determine a user's accessibility on its own and does not need to rely on any telecommunication means. Because the payment process 230 only occurs occasionally (e.g. monthly), the preferred M3DM system 300 and its associated access method work almost all time even in areas where no telecommunication means is available.

To facilitate the payment process 230, the mobile device 200 in the M3DM system 300 preferably uses a cellular phone. Cellular phone provides several advantages: 1) cellular communication has the widest coverage; 2) a user does not need to punch in numbers for device ID and credit card, because device ID can be directly transmitted from the cellular phone to the authorization center and payment can be directly deducted from the cellular account.

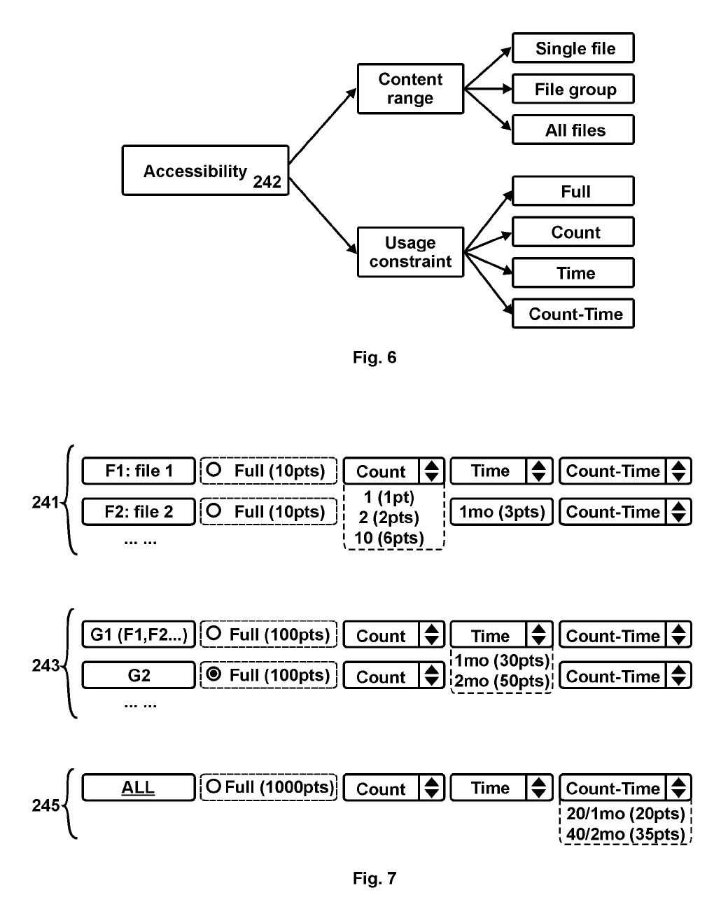

FIG. 6 illustrates a preferred sequence to select accessibility (step 242). It comprises two steps: the first step is to select content range; the second step is to select usage constraint. The content range could be a single file, a file group or all files in the PMC 110; the usage constraint could be full-access (i.e. unlimited playback), count-limited (i.e. the number of playbacks not to exceed a limit), time-limited (i.e. playback must occur within a specified period), count-time-limited (i.e. the number of playbacks within a period not to exceed a limit).

FIG. 7 illustrates a preferred user interface to select accessibility. It comprises three sections 241, 243, 245. They correspond to single file, file group or all files, respectively. For example, in section 241, a user selects the usage constraint for file F1. When he clicks “Count”, a pull-down menu displays three choices: “1 (1 pt)”, “2 (2 pts)”, “10 (6 pts)”, which means if the user selects to playback F1 once, the access fee is 1 point; to playback F1 twice, the access fee is 2 points; to playback F1 for ten times, the access fee is 6 points.

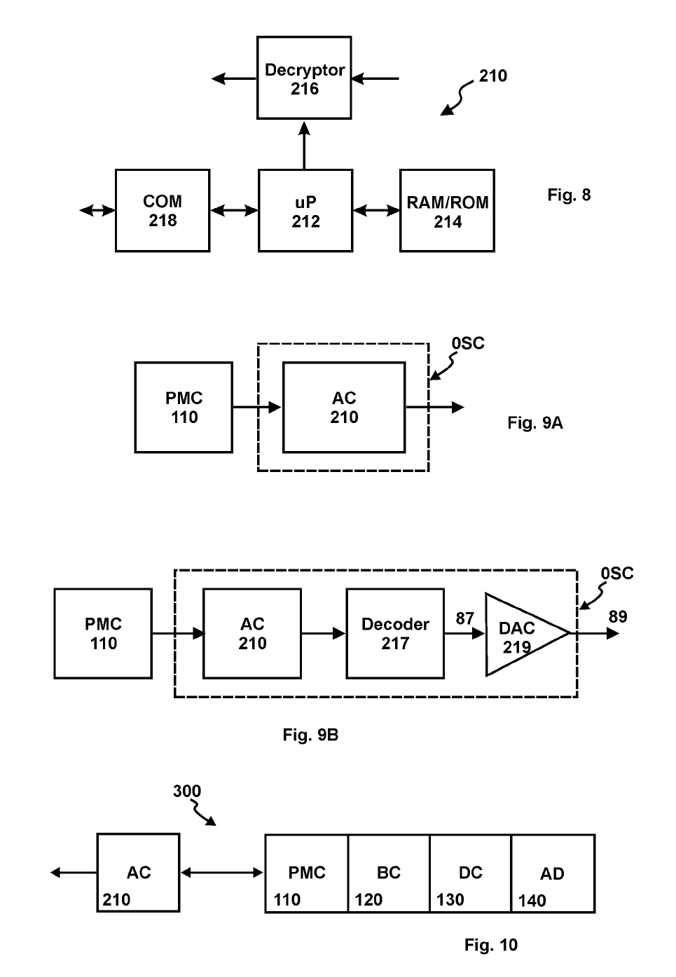

FIG. 8 is a block diagram of a preferred access-control block (AC) 210. It comprises micro-processor 212, memory (including RAM and ROM) 214, decryptor 216 and communication means (COM) 218. ROM 214 stores information such as device ID, account balance, access fees and encryption keys. Some of these information can also be stored in the M3DM 100. Micro-processor 212 determines whether a user is allowed to access certain content. If allowed, the corresponding encryption key will be sent to the decryptor 216. The COM 218 provides information exchange between the M3DM system 300 and the authorization center. It could be telephone (landline or cellular), internet (wired or wireless) or others.

Because the 3D-M memory cells do not occupy substrate 30, the substrate 30 can be used to form substrate circuit 0SC. Accordingly, the present invention discloses an integrated M3DM. In an integrated M3DM, at least a portion of circuit blocks of the mobile device 200 are integrated into the 3D-M substrate 30. FIGS. 9A-9B illustrate two preferred embodiments.

Referring now to FIG. 9A, a first preferred integrated M3DM is illustrated. Its access-control block 210 is integrated into the substrate circuits 0SC. Located underneath the 3D-M array, this access-control block 210 cannot be tampered with. As a result, this preferred embodiment provides excellent access control.

Referring now to FIG. 9B, a second preferred integrated M3DM is illustrated. Besides access-control block 210, its substrate circuit OSC further comprises a decoder 217 and a digital-to-analog converter (DAC) 219. The decoder 217 converts the pre-recorded content data into un-compressed digital format 87. Typical decoders 217 include audio decoders (e.g. mp3 decoder), video decoders (e.g. jpeg decoder, mpeg decoder). Then DAC 219 converts these digital data 87 into analog output signals 89. Analog output signals 89 could use voltage-amplitude modulation, pulse-width modulation (PWM), or pulse-position modulation (PPM). Because the output signals 89 are analog, pirates cannot make perfect “digital” copy of the stored contents. Moreover, because the decoder 217 and DAC 219 are also located underneath the 3D-M array, they cannot be tampered with. This preferred embodiment can achieve excellent access control and impenetrable copyright protection. Its commercial potentials are boundless.

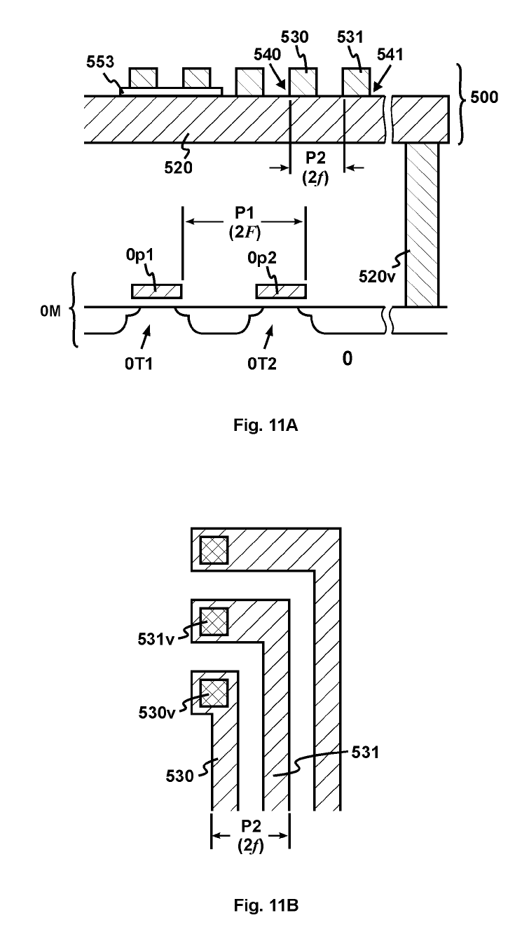

FIG. 10 is a simplified block diagram of a preferred M3DM system containing multi-sourced contents 300. In this preferred embodiment, multi-sourced contents include PMC 110, broadcast contents (BC) 120, downloaded contents (DC) 130 and advertisements (AD) 140. The BC 120 are delivered by broadcast means, e.g. radio signals, TV signals, wireless internet, cellular phone, wired internet or others. They typically comprise latest released movies, songs or books. The DC 130 are downloaded by a user, e.g. from internet. They can be tailored to suit the user's individual needs. The AD 140 can further reduce the access fees—a user will be charged a reduced access fee if advertisement playback is accepted during contents playback. The BC 120, DC 130 and AD 140 are preferably stored in a read-write memory (e.g. flash). It can be integrated with the M3DM 100, or separately located in the mobile device 200. Note that although the preferred embodiment contains all kinds of multi-sourced contents, it may contain just a single kind of multi-sourced contents, or a combination thereof.

The M3DM system containing multi-sourced contents 300 can be easily implemented in a multimedia cellular phone. The multimedia cellular phone uses M3DM to access pre-recorded movies, while using cellular communication to get the recent release. The cellular communication can also carry out the payment process 230 for the pre-recorded movies. The multimedia cellular phone combines both strengths of the “download” and “pre-recorded” models for multimedia distribution and therefore, will be a most preferred M3DM system in the future.

At present, flash memory represents the most advanced transistor technology. In 2007, flash memory in mass production uses the 50 nm technology. As is well known to those skilled in the art, transistor scaling involves many factors, e.g. lithography, gate material, gate dielectric material, channel/source/drain engineering and others. On the other hand, diode scaling is much simpler: it is more or less limited by lithography alone. Thus, diode follows different scaling laws than transistor: 1) the diode minimum feature-size f could be smaller than the transistor minimum feature-size F; 2) the diode scaling can occur at a much faster rate than transistor.

Accordingly, the present invention discloses a narrow-line three-dimensional memory (NL-3DM). It comprises at least one diode-based memory level (3D-M level) stacked above the substrate. The minimum feature-size of the diode-based memory level (3D-M level) is smaller than the contemporary transistor-based memory (e.g. flash). Here, contemporary transistor-based memory refers to the most advanced transistor-based memory that is in mass production at the same time as the diode-based memory. For example, when the contemporary flash memory uses F=50 nm technology, NL-3DM may use f=40 nm technology. Moreover, for flash memory, it takes three years or longer to scale to another generation; while for 3D-M, it may take two years or even shorter. Apparently, NL-3DM has a larger density than contemporary flash memory and this density gap will grow even wider with time.

FIG. 11 A illustrates a narrow-line 3D-MPM. It comprises a diode-based memory level 500 and a transistor-based memory 0M. The diode-based memory level 500 comprises two sets of address-selection lines 520 and 530, 531. Address-selection line 520 could be word line and P-doped; while address-selection line 530, 531 could be bit lines and N-doped. Diodes are formed at the intersections between word line 520 and bit lines 530, 531. Each diode represents a memory cell (540 or 541).

Unlike 3D-EPM, the 3D-MPM memory cell does not comprise antifuse layer and is purely a diode. The digital information stored in each memory cell 540, 541 is determined by the existence or absence of the info-dielectric 553. As a result, 3D-MPM is the easiest to scale among all semiconductor memories. It is most suitable for NL-3DM. The minimum feature-size fin the diode-based memory 500 is half of the pitch (P2) between address-selection lines 530 and 531, i.e. P2=2f, and the minimum feature-size F in the transistor-based memory 0M is half of the pitch (P1) between poly gate 0p1 and 0p2, i.e. P1=2F In a narrow-line 3D-MPM, f<F and f is smaller than the contemporary flash memory. Note that, because transistor 0T1, 0T2 (located in substrate 0) and diodes 540, 541 (located above substrate 0) are formed in separate manufacturing steps, they can be scaled independently.

The inter-level vias 520v, 530v, 531v may use the ftechnology (i.e. the size of the inter-level via is f), or the F technology (i.e. the size of the inter-level via is F). In the preferred embodiment of FIG. 11B, the inter-level vias use the F technology. The address-selection lines 530, 531 are bent by an angle in such a way that a larger via spacing (F instead of f) can be accommodated in the layout (FIG. 11B).

While illustrative embodiments have been shown and described, it would be apparent to those skilled in the art that may more modifications than that have been mentioned above are possible without departing from the inventive concepts set forth therein. For example, besides movies, M3DM can also be used to store textual, audio and/or image contents. Moreover, M3DM can be used to store other video contents, such as video clips. The invention, therefore, is not to be limited except in the spirit of the appended claims.

What is claimed is:

1. A multimedia three-dimensional memory (M3DM), comprising:
a three-dimensional memory (3D-M) comprising a substrate and a plurality of vertically stacked memory levels;
wherein said 3D-M stores at least one movie at an average storage cost per movie comparable to DVD, and said movie has been recorded in said 3D-M before said 3D-M is distributed to a user.

2. The M3DM according to claim 1, wherein said 3D-M comprises a three-dimensional mask-programmable memory (3D-MPM).

3. The M3DM according to claim 1, wherein said average storage cost per movie is less than $0.70.

4. The M3DM according to claim 1, further comprising an access-control block for controlling access to said pre-recorded movie.

5. The M3DM according to claim 1, wherein a user initially obtains said 3D-M at a nominal price and later pays an access fee to access said pre-recorded movie.

6. The M3DM according to claim 5, wherein at least a portion of the hardware cost is recouped through said access fee.

7. The M3DM according to claim 1, further containing textual contents, audio contents, image contents and/or video clips.

8. A multimedia three-dimensional memory (M3DM) system, comprising:
a three-dimensional memory (3D-M) comprising a substrate and a plurality of vertically stacked memory levels, said 3D-M containing a plurality of pre-recorded multimedia contents (PMC);
an access-control block for controlling access to said PMC; and
a mobile device for playing back selected multimedia contents from said PMC;
wherein said PMC have been recorded in said 3D-M before said 3D-M is distributed to a user.

9. The M3DM system according to claim 8, wherein said 3D-M comprises a three-dimensional mask-programmable memory (3D-MPM) or a three-dimensional electrically-programmable memory (3D-EPM).

10. The M3DM system according to claim 8, wherein said mobile device is a cellular phone.

11. The M3DM system according to claim 8, wherein a user initially obtains said 3D-M at a nominal price and later pays an access fee to access selected contents.

12. The M3DM system according to claim 8, wherein said substrate further comprises said access-control block, a decoder and/or a digital-to-analog converter.

13. The M3DM system according to claim 8, further comprising a read-write memory.

14. The M3DM system according to claim 8, further containing broadcast contents, downloaded contents and/or advertisements.

15. The M3DM system according to claim 8, further containing pre-recorded textual contents, pre-recorded audio contents, pre-recorded image contents and/or pre-recorded video contents.

16. A narrow-line three-dimensional memory, comprising:
a substrate having a transistor-based memory, said transistor-based memory comprising a plurality of first address-selection lines in parallel; and
a diode-based memory stacked above and coupled to said substrate through a plurality of inter-level vias, said diode-based memory comprising a plurality of second address-selection lines in parallel;
wherein the minimum pitch of said second address-selection lines is smaller than said first address-selection lines, and the minimum feature-size of said diode-based memory is smaller than contemporary transistor-based memory.

17. The narrow-line three-dimensional memory according to claim 16, wherein at least one dimension of at least a portion of said inter-level vias is larger than the minimum half-pitch of said second address-selection lines.

18. The narrow-line three-dimensional memory according to claim 16, wherein said diode-based memory is a mask-programmable memory.

19. The narrow-line three-dimensional memory according to claim 18, wherein said mask-programmable memory does not comprise an antifuse layer.

20. The narrow-line three-dimensional memory according to claim 18, wherein at least one dimension of at least a portion of said inter-level vias is larger than the minimum half-pitch of said second address-selection lines.
